(19) United States
(12) Patent Application Publication
(10) Pub. No.: US 2011/0022664 A1
(43) Pub. Date: Jan. 27, 2011

(54) Cost Based Email Management System

(75) Inventor: John Ainsworth, Norwood, MA (US)

Correspondence Address: MICHAEL J. BUCHENHORNER, 8540 S.W. 83 STREET, MIAMI, FL, 33143, US

(73) Assignee: COMPUTER ASSOCIATES THINK, INC., Islandia, NY (US)

(21) Appl. No.: 12/509,277

(22) Filed: Jul. 24, 2009

(51) Int. Cl. G06F 15/16

(52) U.S. Cl. 709/206

(57) ABSTRACT

A method for managing email costs includes: identifying a participant of an email message in an email thread; assigning a cumulative cost to the email message; and presenting the email message and the cumulative cost to a recipient of the email message.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of electronic mail (email) and more specifically to a system and method for managing email by a cost associated with each email.

### BACKGROUND OF THE INVENTION

As the volume of email transmissions increases in an organization, the amount of time spent processing email is becoming disproportionate to the value of the email itself. There tends to be a lack of discipline among email users who routinely “Reply/All” or send off a quick response and follow-up with other email and responses rather than taking the time to think and compose a complete response. As the number of recipients and people copied on emails increases, the volume of responses can quickly become a storm. Therefore, there is a need for an email system that overcomes the aforementioned shortcomings.

### SUMMARY OF THE INVENTION

Briefly, according to an embodiment of the present invention, a method for managing email costs includes steps or acts of: identifying a participant of an email message in an email thread; assigning a cumulative cost to an organization of replying to the email message; and presenting the email message and the cumulative cost to a recipient of the email message.

According to an embodiment of the present invention, a system for managing email costs includes: a processor for identifying a participant of an email message in an email thread; assigning a cumulative cost to the email message; a memory for storing the email message; and a user interface for presenting the email message and the cumulative cost to a recipient of the email message.

### BRIEF DESCRIPTION OF THE DRAWINGS

FIG. 1 is a flowchart of a method according to the invention;

FIG. 2 is a high level block diagram showing an information processing system according to the invention;

FIG. 3 is a screen shot showing a display of email cost, according to an embodiment of the present invention;

FIG. 4 is a screen shot showing a difference between a simply reply and reply all, according to an embodiment of the present invention; and

FIG. 5 is a screen shot showing a warning message, according to another embodiment of the present invention.

### DETAILED DESCRIPTION

We describe a system that tracks an accumulated cost to an organization associated with the processing of an email thread.

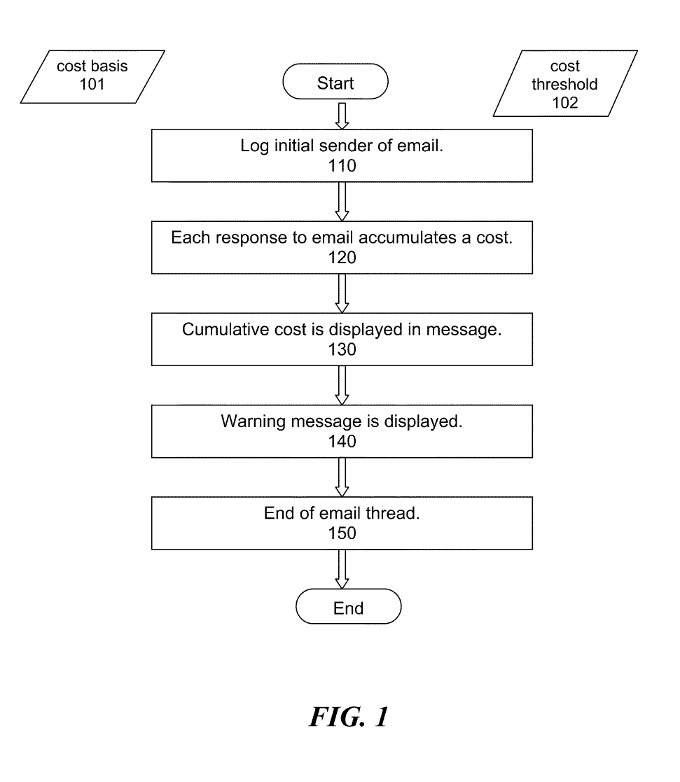

Referring to FIG. 1, there is shown a flow chart 100 illustrating a method for tracking the cost of an email, according to one embodiment of the present invention. The system keeps track of the initial sender of an email, along with the recipients and respondents associated with the email thread. The system then associates a cost with each individual or group, possibly based on information from a corporate directory. This cost is increased as the email thread progresses.

The system permits the cost to be specified on a fixed basis for each person that processed the email; or on a variable basis to include factors such as the size of the email in kilobytes (kb) or megabytes (MB), the length of the email in lines/words, if attachments are included, or potentially based on the amount of time that an individual spends processing the email. For example, email attachments may automatically incur a fixed cost because of the time it takes to open and process them. A more efficient way to disseminate information throughout a company is to place the information (perhaps a document to be downloaded) on the corporate website.

Referring again to FIG. 1, the input 101 to the process is this cost basis. The first step 110 is to log identifying information for the initial sender. This information can be the sender's email address, or an employee ID. Once the initial email is sent with a cost associated with responding to it, then in step 120 each response to that email increases the cumulative cost to the organization of that email thread, according to whatever cost method was pre-selected. For example, one cost method is to allocate a higher cost to emails sent to a group of recipients, rather than an individual recipient. In addition, the cost of the email message may also factor in the “importance level” attributed to the recipient of the email (or even the sender). A data store such as a company directory could be mined in order to retrieve an “importance value” associated with an individual. This value can then be used, along with the cost factor, in determining the total cost.

For example, Table 1 below lists “importance values” associated with company employees, by job title and/or department. Note that a default value can be used if the email participant is not found in the directory.

TABLE 1

| Employee ID | Job Title | Department | Value |
|---|---|---|---|
| 10001 | President | Executive | 1.500 |
| 10010 | Vice President | Executive | 1.489 |
| 10035 | Director | Human Resources | 1.403 |
| 10048 | Manager | Human Resources | 1.329 |
| 10107 | Manager | Human Resources | 1.329 |
| 12003 | Assistant | Human Resources | 1.000 |
| 13178 | Assistant | Human Resources | 1.000 |

Another cost method that can be used is to allocate a higher cost for replying to an email using “Reply All” rather than by using simply “Reply.”

In step 130, after the cumulative cost to the organization is calculated, it can be displayed in the email header for each email in the email thread. Associating a cumulative cost with the email will remind people of the cost and hopefully discourage incurring further costs and reinforce more effective behavior, such as posting information on the corporate website, as mentioned earlier.

There are many different options that may be used for allocating a cost associated with an email, such as allocating a higher cost to emails sent to a domain outside of the company domain.

The system also permits soft and hard limits to be placed on the accumulated cost. The limits can be additional inputs 102 to the process. In step 140, warnings can be displayed when the thresholds are reached with a customizable message reminding the user that it may be more productive to take the discussion out of email and into another communication mechanism such as a conference call. The process ends at step 150 with the termination of that email thread.

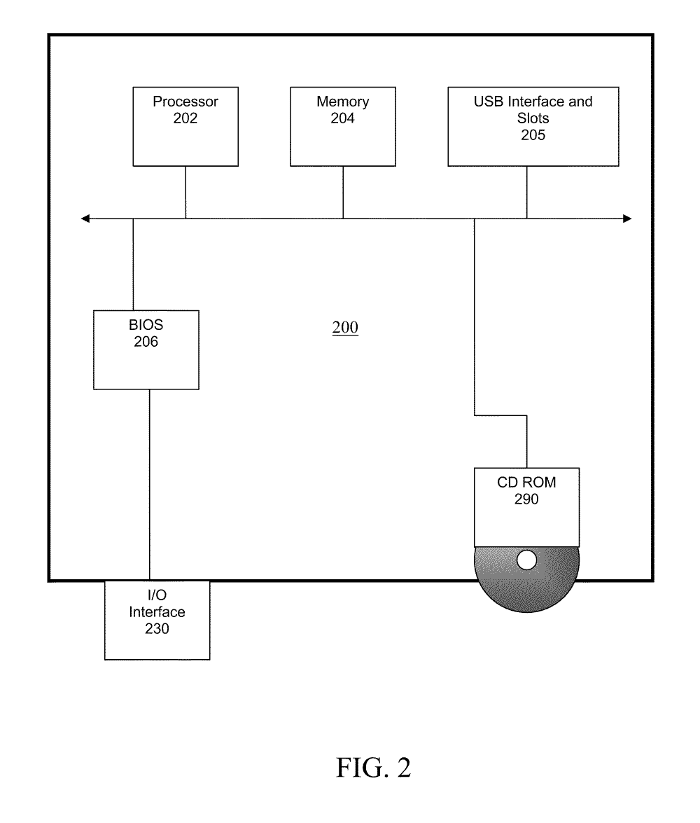

Referring to FIG. 2, there is shown a block diagram of an information processing system 200 in which the invention as described above can be implemented. For purposes of this invention, computer system 200 may represent any type of computer, information processing system or other programmable electronic device, including a client computer, a server computer, a portable computer, an embedded controller, a personal digital assistant, and so on. The computer system 200 may be a stand-alone device or networked into a larger system.

The system 200 could include a number of operators and peripheral devices as shown, including, but not limited to, a processor 202, a memory 204, and an input/output (I/O) subsystem 206. According to an embodiment of the invention a user of the system 200 is presented with emails including their cost shown on the I/O interface 230.

According to another embodiment of the invention, a computer readable medium, such as a CDROM 290 can include program instructions for operating the system 200 according to the invention. What has been shown and discussed is a highly-simplified depiction of a programmable computer apparatus. Those skilled in the art will appreciate that other low-level components and connections are required in any practical application of a computer apparatus.

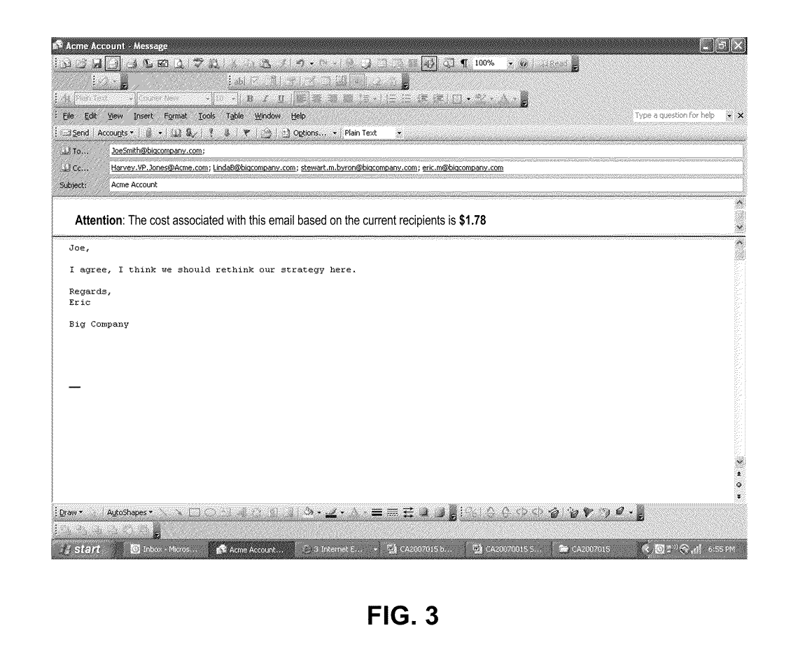

Referring to FIG. 3, we show a basic email screenshot of the start of an email thread. The screenshot illustrates an example of how the cost associated with an original email could be displayed to the email author at the time that the recipients are specified as part of email composition.

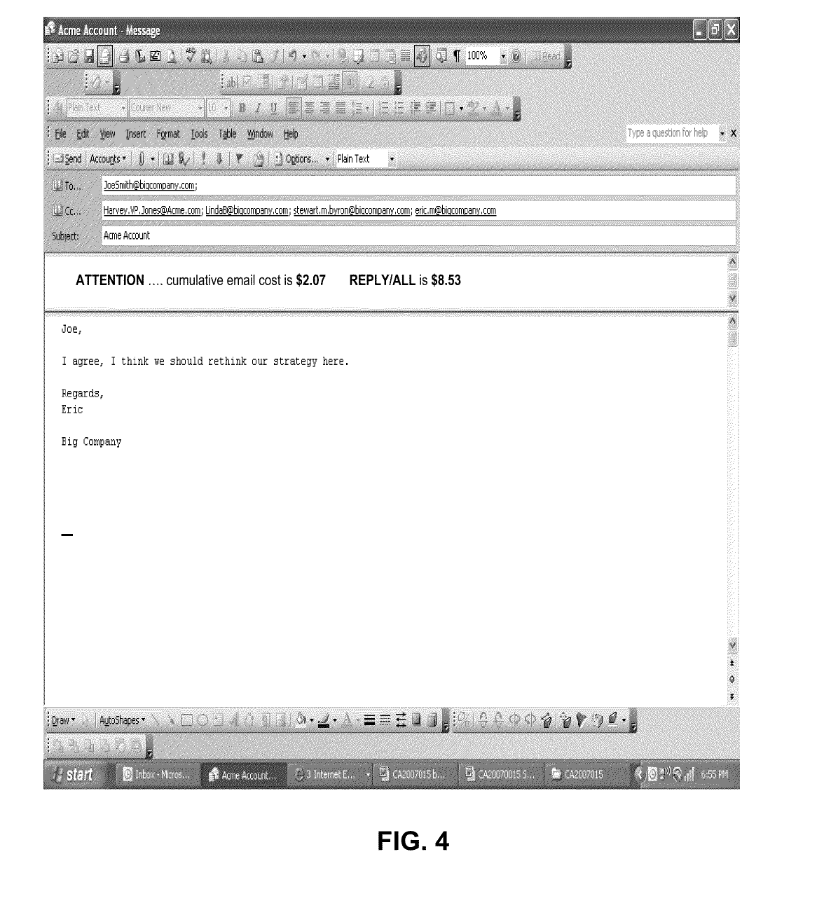

Referring to FIG. 4, we show a basic email screenshot with reply all selected. The screenshot illustrates an example of an email thread that has been active for several iterations, showing a cumulative cost for the email and an estimated cost for an additional reply/all”

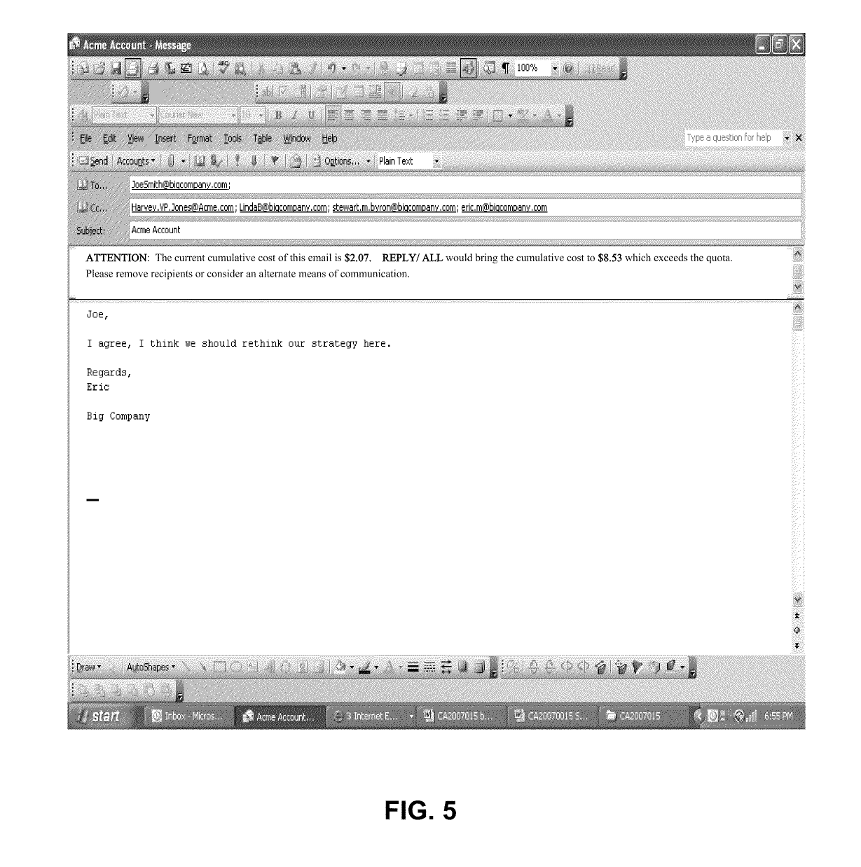

Referring to FIG. 5, we show an email screenshot showing the warning message about the cumulative cost exceeding the threshold value.

Therefore, while there has been described what is presently considered to be the preferred embodiment, it will understood by those skilled in the art that other modifications can be made within the spirit of the invention.

We claim:

1. A method comprising:
using an input/output interface for receiving an email message to be transmitted as part of an email thread;
using a data store for identifying a participant of the email message;
using a processor for assigning a cumulative cost to the email message, said cumulative cost reflecting the cost to an organization of replying to the email message; and
using the input/output interface for presenting the email message and the cumulative cost to a recipient of the email message.

2. The method of claim 1, wherein presenting the cumulative cost comprises displaying said cumulative cost in a header of the email message.

3. The method of claim 1, wherein the cumulative cost is assigned by a receiving node when the email message is received.

4. The method of claim 1, wherein the cumulative cost is assigned by a sending node.

5. The method of claim 1, wherein assigning the cumulative cost comprises:
receiving a pre-determined cost factor;
retrieving a value from a data store, the value comprising a level attributed to the email message participant; and
calculating the cumulative cost of the email message as a product of the pre-determined cost factor and the value from the data store, plus the cumulative cost already assigned to the email message; and
wherein presenting the email message comprises presenting the calculated cumulative cost on a portion of the email message.

6. The method of claim 5 wherein the value has a default value.

7. The method of claim 5 wherein the participant is a sender of the email message.

8. The method of claim 5 wherein the participant is a recipient of the email message.

9. The method of claim 5 wherein the predetermined cost factor is determined based on at least one selected from a group consisting of: length of the email message in kilobytes, length of the email message in lines, number of respondents, whether an attachment is present, and a domain associated with the recipient.

10. The method of claim 5 wherein the step of presenting the calculated cumulative cost comprises presenting a first cumulative cost for submitting a simple reply and a second cumulative cost for submitting a reply to all participants.

11. The method of claim 5 further comprising receiving a cumulative cost threshold.

12. The method of claim 11 wherein the step of presenting the calculated cumulative cost further comprises presenting a warning that the threshold has been reached when the cumulative cost reaches the threshold.

13. The method of claim 5 wherein the pre-determined cost factor comprises a default value.

14. The method of claim 5 wherein the cumulative cost already assigned to the email message is zero at a start of the email thread.

15. An information processing system comprising:
a processor for:
receiving an email message to be transmitted as part of an email thread;
identifying a participant of the email message; and
assigning a cumulative cost to the email message, said cumulative cost reflecting the cost to an organization of replying to the email message;
a memory for storing the email message; and
a user interface for presenting the email message and the cumulative cost to a recipient of the email message.

16. A computer readable storage medium comprising program code with instructions for:
using an input/output interface for receiving an email message to be transmitted as part of an email thread;
using a data store for identifying a participant of the email message;
using a processor for assigning a cumulative cost to the email message, said cumulative cost reflecting the cost to an organization of replying to the email message; and
using the input/output interface for presenting the email message and the cumulative cost to a recipient of the email message.
